(19) United States
(12) Patent Application Publication
(10) Pub. No.: US 2014/0302463 A1
(43) Pub. Date: Oct. 9, 2014

(54) MNEMONIC-BASED LANGUAGE-LEARNING SYSTEM AND METHOD

(71) Applicants: Rafael Lisitsa, Bellevue, WA (US); Mark Sestak, Vancouver (CA); Gennady Feller, Belmont, CA (US)

(72) Inventors: Rafael Lisitsa, Bellevue, WA (US); Mark Sestak, Vancouver (CA); Gennady Feller, Belmont, CA (US)

(21) Appl. No.: 14/187,142

(22) Filed: Feb. 21, 2014

Related U.S. Application Data
(63) Continuation-in-part of application No. 12/220,426, filed on Jul. 24, 2008, now abandoned.
Application No. 12/220,426 is a continuation of application No. 12/074,399, filed on Mar. 3, 2008, now abandoned.
(60) Provisional application No. 60/905,055, filed on Mar. 5, 2007.

(51) Int. Cl. G09B 19/06; G09B 5/00

(52) U.S. Cl. CPC G09B 19/06; G09B 5/00
USPC 434/157

(57) ABSTRACT

The current document discloses computer-based methods and systems that employ mnemonics for teaching foreign languages to students of foreign languages. The currently disclosed computer-based and mnemonics-based language learning system is, in the described implementation, a distributed computational system that provides a collaborative computational environment in which students of foreign languages create, edit, discuss, and use mnemonics-based dictionaries and language-learning resources.

### CROSS-REFERENCES TO RELATED APPLICATIONS

This application is a continuation-in-part of application Ser. No. 12/220,426, filed Jul. 24, 2008, which is a continuation of application Ser. No. 12/074,399, filed Mar. 3, 2008, which claims the benefit of Provisional Application No. 60/905,055, filed Mar. 5, 2007.

### TECHNICAL FIELD

The current document is related to language learning and, in particular, to computer-based and mnemonics-based language-learning systems and methods.

### BACKGROUND

Language education is a broad field of endeavor that encompasses classroom language learning in schools and universities, enormous numbers of published textbooks, dictionaries, and other language-reference sources, and, in more recent years, a wide variety of computer-based language-learning applications. Many different approaches are used to teach natural languages to non-native speakers, including repetition and exercises, lavishly illustrated language texts motivated to associate visual images with vocabulary words and phrases, and systematic discussions of syntax, grammar, word origins, and cultural aspects of languages.

A mnemonic is a memory aid that, when associated with a foreign word or phrase, assists a language learner in remembering the word or phrase. A mnemonic may be one or more of rhymes, easily remembered phrases, pictures, and various combinations of rhymes, phrases, and pictures.

Mnemonics find useful application in the study of foreign languages. A student of a foreign language may far more easily assimilate a word or phrase in the foreign language when that word or phrase is associated with a mnemonic. As one example, an English-speaking student of French may use the mnemonic “beans wear hairy coats” for association with and memorization of the French word “haricots.”

### SUMMARY

The current document discloses computer-based methods and systems that employ mnemonics for teaching foreign languages to students of foreign languages. The currently disclosed computer-based and mnemonics-based language learning system (“LLS”) is, in the described implementation, a distributed computational system that provides a collaborative computational environment in which students of foreign languages create, edit, discuss, and use mnemonics-based dictionaries and language-learning resources.

### BRIEF DESCRIPTION OF THE DRAWINGS

FIG. 1 provides a general architectural diagram for various types of computers and other processor-controlled devices.

FIG. 2 illustrates generalized hardware and software components of a general-purpose computer system.

FIG. 3 illustrates generalized hardware and software components of a general-purpose computer system that includes a virtualization layer.

FIG. 4 illustrates an Internet-connected distributed computer system.

FIG. 5 illustrates cloud computing.

FIG. 6 illustrates electronic communications between a client and server computer.

FIG. 7 illustrates the role of resources in RESTful APIs.

FIGS. 8A-D illustrate four basic verbs, or operations, provided by the HTTP application-layer protocol used in RESTful applications.

FIGS. 9A-R illustrate, using screenshots, one implementation of a user interface provided to users of the currently disclosed LLS.

FIG. 10 shows a block diagram of one implementation of the currently disclosed LLS.

FIG. 11 illustrates the storage of information elements by the language-learning-database service.

FIG. 12 shows a more detailed representation of a word data structure that is used, by the language-learning-database service, to store information associated with a particular foreign-language word.

FIG. 13 illustrates a specific example of a word data structure, described generally above with reference to FIG. 12.

FIG. 14 provides a block diagram that illustrates aggregation of information by the LLS.

FIG. 15 provides a control-flow-diagram illustration of the basic operation of the currently disclosed LLS.

FIG. 16 provides a similar control-flow diagram to that provided in FIG. 15 with a client-side application or component of the LLS.

### DETAILED DESCRIPTION

The description of the computer-based and mnemonics-based language learning system (“LLS”) to which the current document is directed is provided in three sections, below. A first section discusses hardware and communications platforms on which the LLS is based. A second section provides a screenshot-based illustration of the types of interfaces provided by the LLS to users of the LLS. A third section discusses one implementation of the currently disclosed LLS.

### Hardware and Communications Platforms

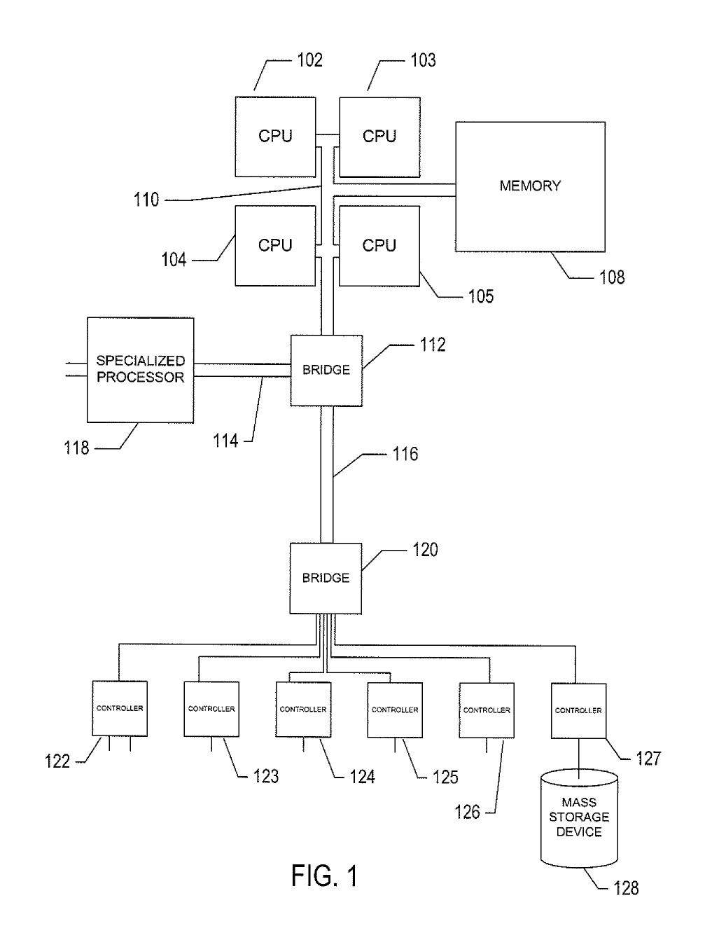

FIG. 1 provides a general architectural diagram for various types of computers and other processor-controlled devices. The high-level architectural diagram may describe a modem computer system, such as a personal computer or server. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources.

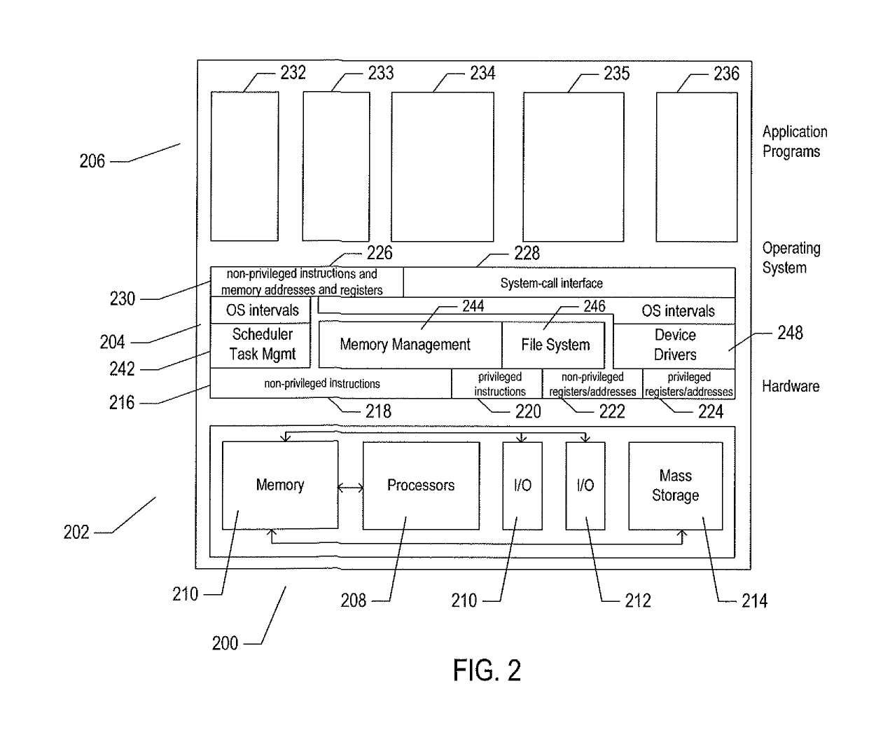

FIG. 2 illustrates generalized hardware and software components of a general-purpose computer system. The computer system 200 is often considered to include three fundamental layers: (1) a hardware layer or level 202; (2) an operating-system layer or level 204; and (3) an application-program layer or level 206. The hardware layer 202 includes one or more processors 208, system memory 210, various different types of input-output (“I/O”) devices 210 and 212, and mass-storage devices 214. Of course, the hardware level also includes many other components, including power supplies, internal communications links and busses, specialized integrated circuits, many different types of processor-controlled or microprocessor-controlled peripheral devices and controllers, and many other components. The operating system 204 interfaces to the hardware level 202 through a low-level operating system and hardware interface 216 generally comprising a set of non-privileged computer instructions 218, a set of privileged computer instructions 220, a set of non-privileged registers and memory addresses 222, and a set of privileged registers and memory addresses 224. In general, the operating system exposes non-privileged instructions, non-privileged registers, and non-privileged memory addresses 226 and a system-call interface 228 as an operating-system interface 230 to application programs 232-236 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 242, memory management 244, a file system 246, device drivers 248, and many other components and modules.

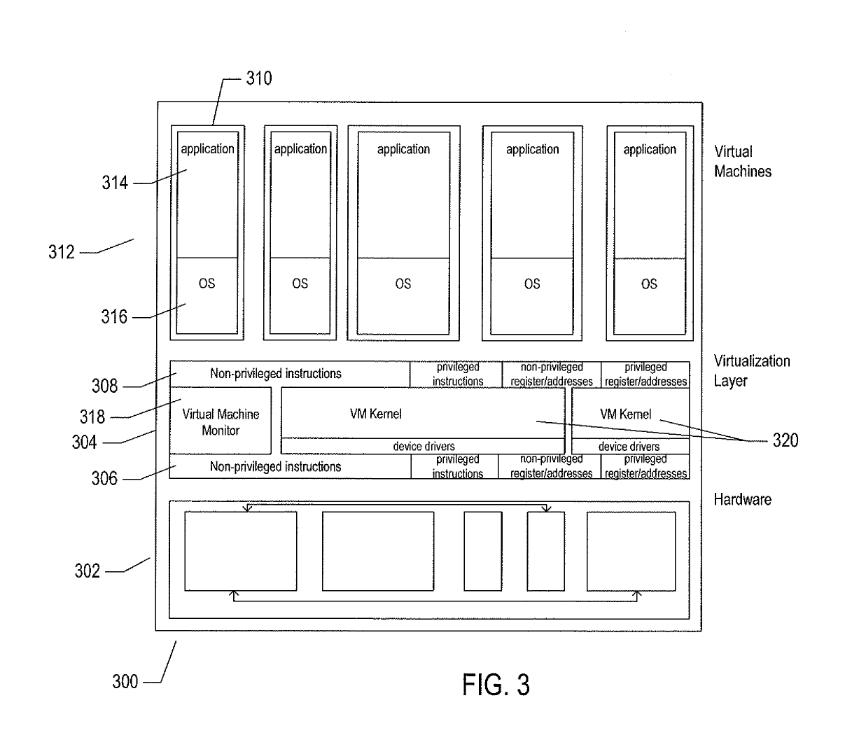

FIG. 3 illustrates generalized hardware and software components of a general-purpose computer system that includes a virtualization layer. FIG. 3 uses the same illustration conventions as used in FIG. 2. In particular, the computer system 300 in FIG. 3 includes the same hardware layer 302 as the hardware layer 402 shown in FIG. 2. However, rather than providing an operating system layer directly above the hardware layer, as in FIG. 2, the virtualized computing environment illustrated in FIG. 3 features a virtualization layer 304 that interfaces through a virtualization-layer/hardware-layer interface 306, equivalent to interface 216 in FIG. 2, to the hardware. The virtualization layer provides a hardware-like interface 308 to a number of virtual machines, such as virtual machine 310, executing above the virtualization layer in a virtual-machine layer 312. Each virtual machine includes one or more application programs or other higher-level computational entities packaged together with an operating system, such as application 314 and operating system 316 packaged together within virtual machine 310. Each virtual machine is thus equivalent to the operating-system layer 204 and application-program layer 206 in the general-purpose computer system shown in FIG. 2. Each operating system within a virtual machine interfaces to the virtualization-layer interface 308 rather than to the actual hardware interface 306. The virtualization layer partitions hardware resources into abstract virtual-hardware layers to which each operating system within a virtual machine interfaces. The operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 308 may differ for different operating systems. For example, the virtualization layer is generally able to provide virtual hardware interfaces for a variety of different types of computer hardware. This allows, as one example, a virtual machine that includes an operating system designed for a particular computer architecture to run on hardware of a different architecture. The number of virtual machines need not be equal to the number of physical processors or even a multiple of the number of processors. The virtualization layer includes a virtual-machine-monitor module 318 that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the operating system within a virtual machine accesses virtual privileged instructions, virtual privileged registers, and virtual privileged memory through the virtualization-layer interface 308, the accesses may result in execution of virtualization-layer code to simulate or emulate the privileged resources. The virtualization layer additionally includes a kernel module 320 that manages memory, communications, and data-storage machine resources on behalf of executing virtual machines. The kernel, for example, may maintain shadow page tables on each virtual machine so that hardware-level virtual-memory facilities can be used to process memory accesses. The kernel may additionally include routines that implement virtual communications and data-storage devices as well as device drivers that directly control the operation of underlying hardware communications and data-storage devices. Similarly, the kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

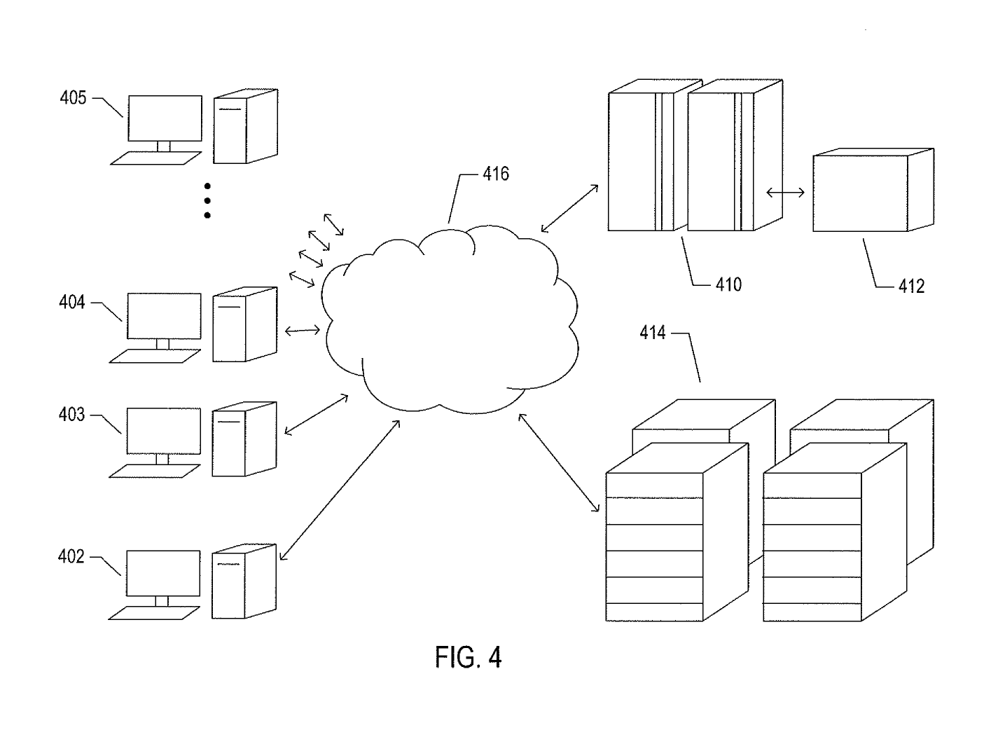

FIG. 4 illustrates an Internet-connected distributed computer system. FIG. 4 shows a typical distributed system in which a large number of PCs 402-405, a high-end distributed mainframe system 410 with a large data-storage system 412, and a large computer center 414 with large numbers of rack-mounted servers or blade servers all interconnected through various communications and networking systems that together comprise the Internet 416. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

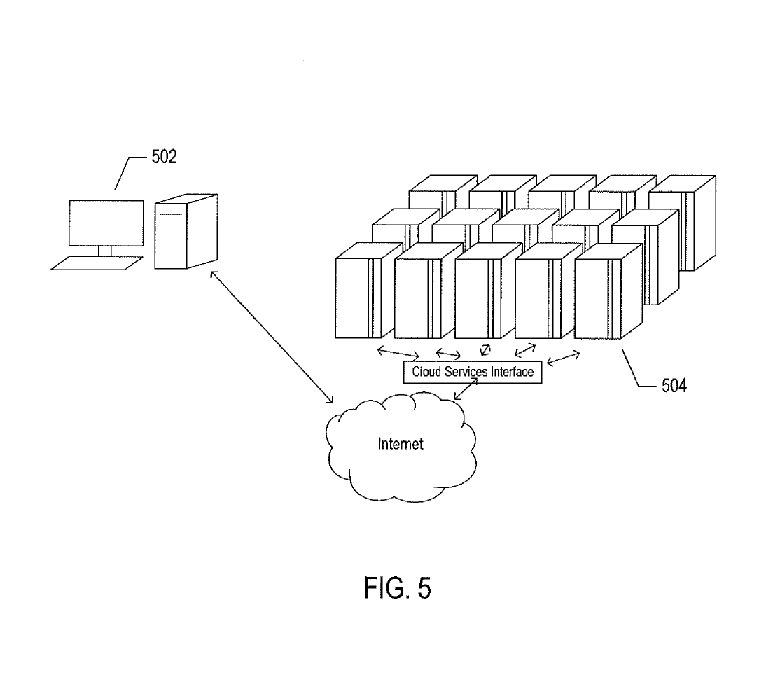

FIG. 5 illustrates cloud computing. In the recently developed cloud-computing paradigm, computing cycles and data-storage facilities are provided to organizations and individuals by cloud-computing providers. In FIG. 5, a user using a personal computer 502 accesses a service provided by an organization that has implemented server-side applications to execute in a public cloud 504. The organization can configure virtual computer systems and even entire virtual data centers and can launch execution of server-side application programs on the virtual computer systems and virtual data centers in order to carry out any of many different types of computational tasks Cloud-computing facilities are intended to provide computational bandwidth and data-storage services much as utility companies provide electrical power and water to consumers. Cloud computing provides enormous advantages to organizations which do not wish to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

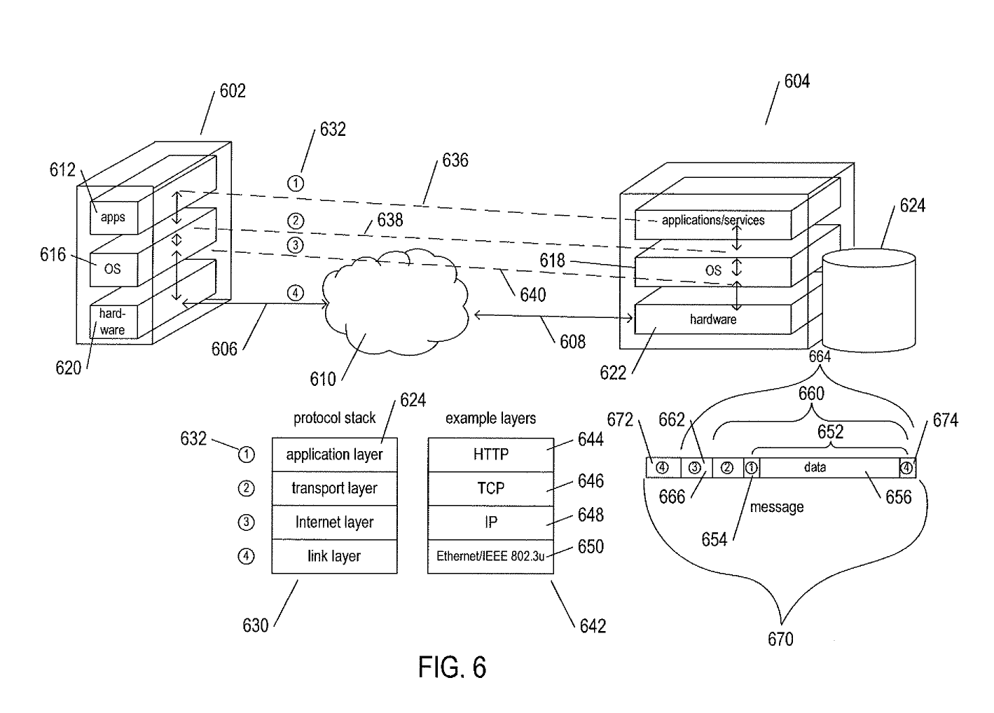

FIG. 6 illustrates electronic communications between a client and server computer. In FIG. 6, a client computer 602 is shown to be interconnected with a server computer 604 via local communication links 606 and 608 and a complex distributed intermediary communications system 610, such as the Internet. This complex communications system may include a large number of individual computer systems and many types of electronic communications media, including wide-area networks, public switched telephone networks, wireless communications, satellite communications, and many other types of electronics-communications systems and intermediate computer systems, routers, bridges, and other device and system components. Both the server and client computers are shown to include three basic internal layers including an applications layer 612 in the client computer and a corresponding applications and services layer 614 in the server computer, an operating-system layer 616 and 618, and a hardware layer 620 and 622. The server computer 604 is additionally associated with an internal, peripheral, or remote data-storage subsystem 624. The hardware layers 620 and 622 may include the components discussed above with reference to FIG. 1 as well as many additional hardware components and subsystems, such as power supplies, cooling fans, switches, auxiliary processors, and many other mechanical, electrical, electromechanical, and electro-optical-mechanical components. The operating system 616 and 618 represents the general control system of both a client computer 602 and a server computer 604. The operating system interfaces to the hardware layer through a set of registers that, under processor control, are used for transferring data, including commands and stored information, between the operating system and various hardware components. The operating system also provides a complex execution environment in which various application programs, including database management systems, web browsers, web services, and other application programs execute. In many cases, modem computer systems employ an additional layer between the operating system and the hardware layer, referred to as a “virtualization layer,” that interacts directly with the hardware and provides a virtual-hardware-execution environment for one or more operating systems.

Client systems may include any of many types of processor-controlled devices, including tablet computers, laptop computers, mobile smart phones, and other such processor-controlled devices. These various types of clients may include only a subset of the components included in a desktop personal component as well components not generally included in desktop personal computers.

Electronic communications between computer systems generally comprises packets of information, referred to as datagrams, transferred from client computers to server computers and from server computers to client computers. In many cases, the communications between computer systems is commonly viewed from the relatively high level of an application program which uses an application-layer protocol for information transfer. However, the application-layer protocol is implemented on top of additional layers, including a transport layer, Internet layer, and link layer. These layers are commonly implemented at different levels within computer systems. Each layer is associated with a protocol for data transfer between corresponding layers of computer systems. These layers of protocols are commonly referred to as a “protocol stack.” In FIG. 6, a representation of a common protocol stack 630 is shown below the interconnected server and client computers 604 and 602. The layers are associated with layer numbers, such as layer number “1” 632 associated with the application layer 634. These same layer numbers are used in the depiction of the interconnection of the client computer 602 with the server computer 604, such as layer number “1” 632 associated with a horizontal dashed line 636 that represents interconnection of the application layer 612 of the client computer with the applications/services layer 614 of the server computer through an application-layer protocol. A dashed line 636 represents interconnection via the application-layer protocol in FIG. 6, because this interconnection is logical, rather than physical. Dashed-line 638 represents the logical interconnection of the operating-system layers of the client and server computers via a transport layer. Dashed line 640 represents the logical interconnection of the operating systems of the two computer systems via an Internet-layer protocol. Finally, links 606 and 608 and cloud 610 together represent the physical communications media and components that physically transfer data from the client computer to the server computer and from the server computer to the client computer. These physical communications components and media transfer data according to a link-layer protocol. In FIG. 6, a second table 642 aligned with the table 630 that illustrates the protocol stack includes example protocols that may be used for each of the different protocol layers. The hypertext transfer protocol (“HTTP”) may be used as the application-layer protocol 644, the transmission control protocol (“TCP”) 646 may be used as the transport-layer protocol, the Internet protocol 648 (“IP”) may be used as the Internet-layer protocol, and, in the case of a computer system interconnected through a local Ethernet to the Internet, the Ethernet/IEEE 802.3u protocol 650 may be used for transmitting and receiving information from the computer system to the complex communications components of the Internet. Within cloud 610, which represents the Internet, many additional types of protocols may be used for transferring the data between the client computer and server computer.

Consider the sending of a message, via the HTTP protocol, from the client computer to the server computer. An application program generally makes a system call to the operating system and includes, in the system call, an indication of the recipient to whom the data is to be sent as well as a reference to a buffer that contains the data. The data and other information are packaged together into one or more HTTP datagrams, such as datagram 652. The datagram may generally include a header 654 as well as the data 656, encoded as a sequence of bytes within a block of memory. The header 654 is generally a record composed of multiple byte-encoded fields. The call by the application program to an application-layer system call is represented in FIG. 6 by solid vertical arrow 658. The operating system employs a transport-layer protocol, such as TCP, to transfer one or more application-layer datagrams that together represent an application-layer message. In general, when the application-layer message exceeds some threshold number of bytes, the message is sent as two or more transport-layer messages. Each of the transport-layer messages 660 includes a transport-layer-message header 662 and an application-layer datagram 652. The transport-layer header includes, among other things, sequence numbers that allow a series of application-layer datagrams to be reassembled into a single application-layer message. The transport-layer protocol is responsible for end-to-end message transfer independent of the underlying network and other communications subsystems, and is additionally concerned with error control, segmentation, as discussed above, flow control, congestion control, application addressing, and other aspects of reliable end-to-end message transfer. The transport-layer datagrams are then forwarded to the Internet layer via system calls within the operating system and are embedded within Internet-layer datagrams 664, each including an Internet-layer header 666 and a transport-layer datagram. The Internet layer of the protocol stack is concerned with sending datagrams across the potentially many different communications media and subsystems that together comprise the Internet. This involves routing of messages through the complex communications systems to the intended destination. The Internet layer is concerned with assigning unique addresses, known as “IP addresses,” to both the sending computer and the destination computer for a message and routing the message through the Internet to the destination computer. Internet-layer datagrams are finally transferred, by the operating system, to communications hardware, such as a network-interface controller (“NIC”) which embeds the Internet-layer datagram 664 into a link-layer datagram 670 that includes a link-layer header 672 and generally includes a number of additional bytes 674 appended to the end of the Internet-layer datagram. The link-layer header includes collision-control and error-control information as well as local-network addresses. The link-layer packet or datagram 670 is a sequence of bytes that includes information introduced by each of the layers of the protocol stack as well as the actual data that is transferred from the source computer to the destination computer according to the application-layer protocol.

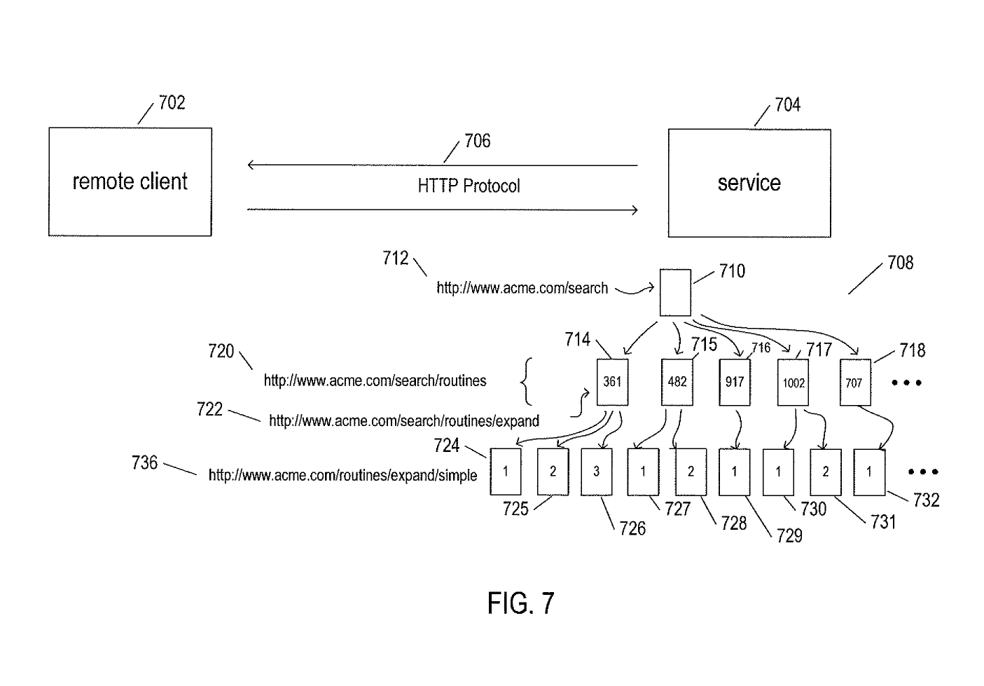

Next, the RESTful approach to web-service APIs is described, beginning with FIG. 7. FIG. 7 illustrates the role of resources in RESTful APIs. In FIG. 7, and in subsequent figures, a remote client 702 is shown to be interconnected and communicating with a service provided by one or more service computers 704 via the HTTP protocol 706. Many RESTful APIs are based on the HTTP protocol. Thus, the focus is on the application layer in the following discussion. However, as discussed above with reference to FIG. 6, the remote client 702 and service provided by one or more server computers 704 are, in fact, physical systems with application, operating-system, and hardware layers that are interconnected with various types of communications media and communications subsystems, with the HTTP protocol the highest-level layer in a protocol stack implemented in the application, operating-system, and hardware layers of client computers and server computers. The service may be provided by one or more server computers, as discussed above in a preceding section. As one example, a number of servers may be hierarchically organized as various levels of intermediary servers and end-point servers. However, the entire collection of servers that together provide a service are addressed by a domain name included in a uniform resource identifier (“URI”), as further discussed below. A RESTful API is based on a small set of verbs, or operations, provided by the HTTP protocol and on resources, each uniquely identified by a corresponding URI. Resources are logical entities, information about which is stored on one or more servers that together comprise a domain. URIs are the unique names for resources. A resource about which information is stored on a server that is connected to the Internet has a unique URI that allows that information to be accessed by any client computer also connected to the Internet with proper authorization and privileges. URIs are thus globally unique identifiers, and can be used to specify resources on server computers throughout the world. A resource may be any logical entity, including people, digitally encoded documents, organizations, services, routines, and other such entities that can be described and characterized by digitally encoded information. A resource is thus a logical entity. Digitally encoded information that describes the resource and that can be accessed by a client computer from a server computer is referred to as a “representation” of the corresponding resource. As one example, when a resource is a web page, the representation of the resource may be a hypertext markup language (“HTML”) encoding of the resource. As another example, when the resource is an employee of a company, the representation of the resource may be one or more records, each containing one or more fields, that store information characterizing the employee, such as the employee's name, address, phone number, job title, employment history, and other such information.

In the example shown in FIG. 7, the web servers 704 provides a RESTful API based on the HTTP protocol 706 and a hierarchically organized set of resources 708 that allow clients of the service to access information about the customers and orders placed by customers of the Acme Company. This service may be provided by the Acme Company itself or by a third-party information provider. All of the customer and order information is collectively represented by a customer information resource 710 associated with the URI “http://www.acme.com/customerInfo” 712. As discussed further, below, this single URI and the HTTP protocol together provide sufficient information for a remote client computer to access any of the particular types of customer and order information stored and distributed by the service 704. A customer information resource 710 represents a large number of subordinate resources. These subordinate resources include, for each of the customers of the Acme Company, a customer resource, such as customer resource 714. All of the customer resources 714-718 are collectively named or specified by the single URI “http://www.acme.com/customerInfo/customers” 720. Individual customer resources, such as customer resource 714, are associated with customer-identifier numbers and are each separately addressable by customer-resource-specific URIs, such as URI “http://www.acme.com/customerInfo/customers/361” 722 which includes the customer identifier “361” for the customer represented by customer resource 714. Each customer may be logically associated with one or more orders. For example, the customer represented by customer resource 714 is associated with three different orders 724-726, each represented by an order resource. All of the orders are collectively specified or named by a single URI “http://www.acme.com/customerInfo/orders” 736. All of the orders associated with the customer represented by resource 714, orders represented by order resources 724-726, can be collectively specified by the URI “http://www.acme.com/customerInfo/customers/361/orders” 738. A particular order, such as the order represented by order resource 724, may be specified by a unique URI associated with that order, such as URI “http://www.acme.com/customerInfo/customers/361/orders/1” 740, where the final “1” is an order number that specifies a particular order within the set of orders corresponding to the particular customer identified by the customer identifier “361.”

In one sense, the URIs bear similarity to path names to files in file directories provided by computer operating systems. However, it should be appreciated that resources, unlike files, are logical entities rather than physical entities, such as the set of stored bytes that together compose a file within a computer system. When a file is accessed through a path name, a copy of a sequence of bytes that are stored in a memory or mass-storage device as a portion of that file are transferred to an accessing entity. By contrast, when a resource is accessed through a URI, a server computer returns a digitally encoded representation of the resource, rather than a copy of the resource. For example, when the resource is a human being, the service accessed via a URI specifying the human being may return alphanumeric encodings of various characteristics of the human being, a digitally encoded photograph or photographs, and other such information. Unlike the case of a file accessed through a path name, the representation of a resource is not a copy of the resource, but is instead some type of digitally encoded information with respect to the resource.

In the example RESTful API illustrated in FIG. 7, a client computer can use the verbs, or operations, of the HTTP protocol and the top-level URI 712 to navigate the entire hierarchy of resources 708 in order to obtain information about particular customers and about the orders that have been placed by particular customers.

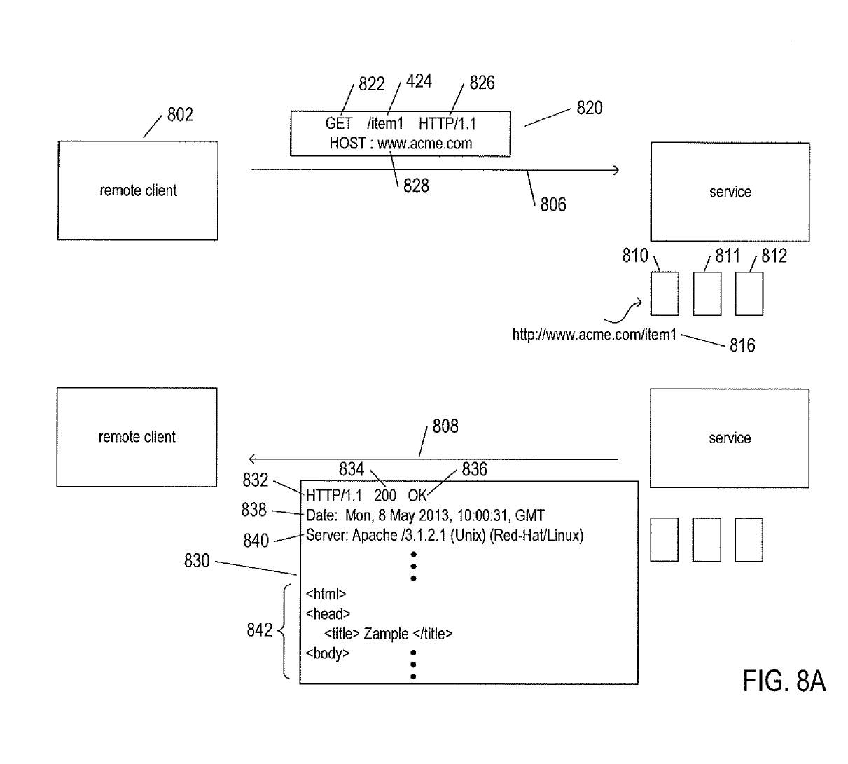

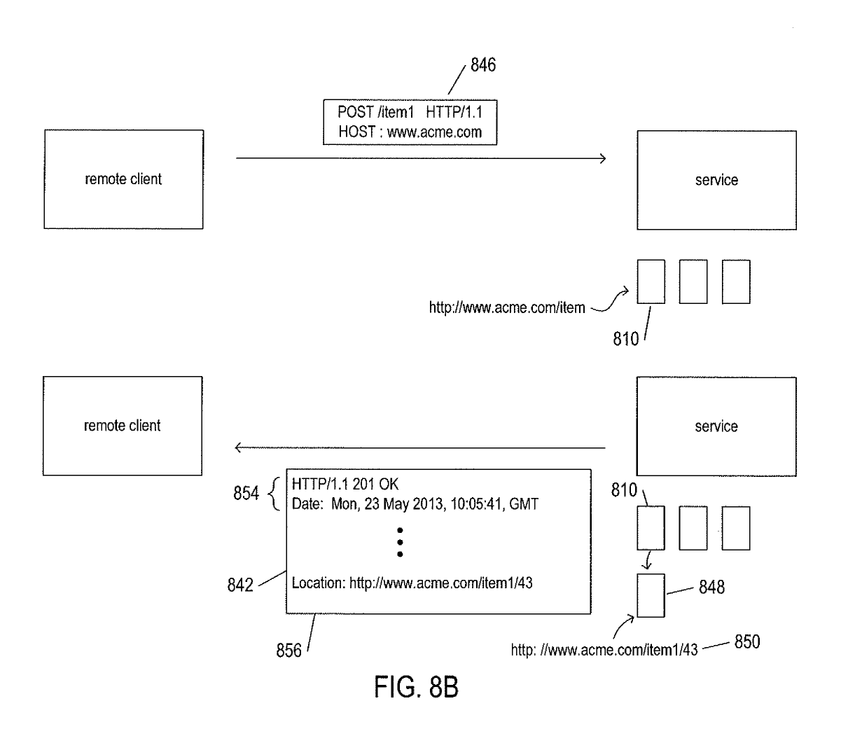

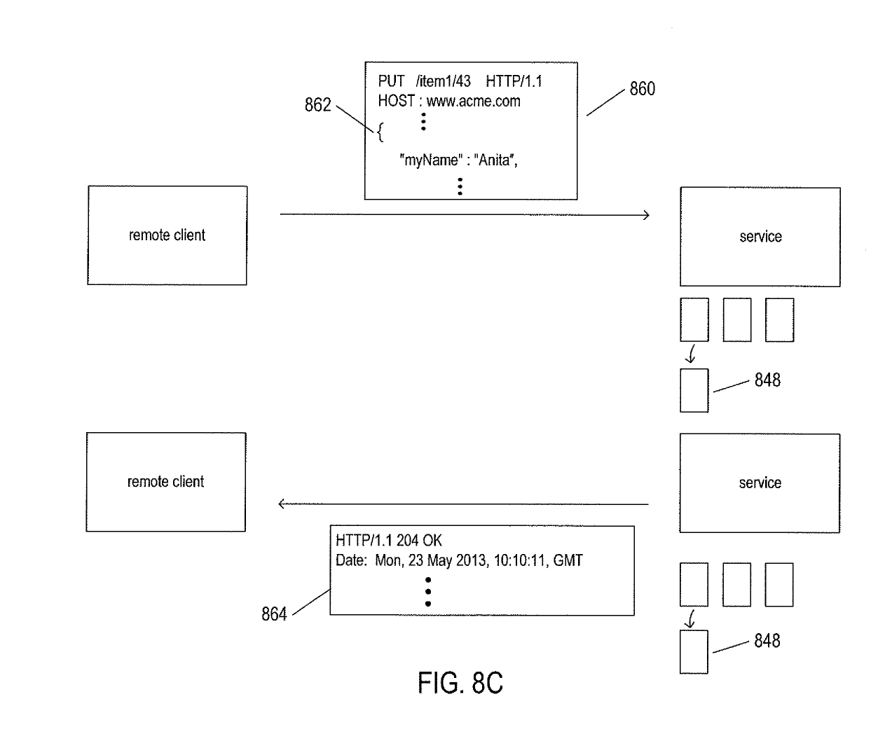

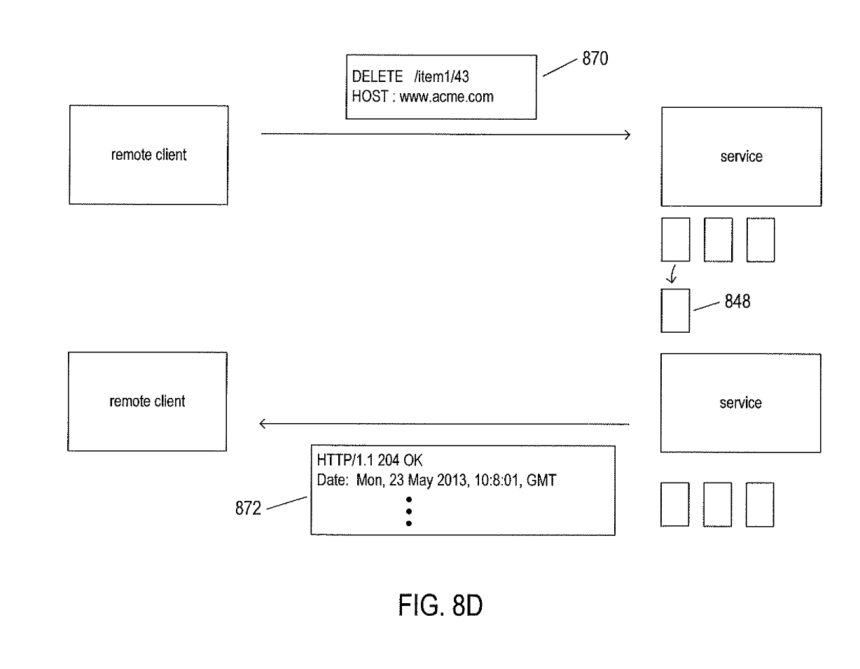

FIGS. 8A-D illustrate four basic verbs, or operations, provided by the HTTP application-layer protocol used in RESTful applications. RESTful applications are client/server protocols in which a client issues an HTTP request message to a service or server and the service or server responds by returning a corresponding HTTP response message. FIGS. 8A-D use the illustration conventions discussed above with reference to FIG. 7 with regard to the client, service, and HTTP protocol. For simplicity and clarity of illustration, in each of these figures, a top portion illustrates the request and a lower portion illustrates the response. The remote client 802 and service 804 are shown as labeled rectangles, as in FIG. 7. A right-pointing solid arrow 806 represents sending of an HTTP request message from a remote client to the service and a left-pointing solid arrow 808 represents sending of a response message corresponding to the request message by the service to the remote client. For clarity and simplicity of illustration, the service 804 is shown associated with a few resources 810-812.

FIG. 8A illustrates the GET request and a typical response. The GET request requests the representation of a resource identified by a URI from a service. In the example shown in FIG. 8A, the resource 810 is uniquely identified by the URI “http://www.acme.com/item1” 816. The initial substring “http://www.acme.com” is a domain name that identifies the service. Thus, URI 816 can be thought of as specifying the resource “item1” that is located within and managed by the domain “www.acme.com.” The GET request 820 includes the command “GET” 822, a relative resource identifier 824 that, when appended to the domain name, generates the URI that uniquely identifies the resource, and in an indication of the particular underlying application-layer protocol 826. A request message may include one or more headers, or key/value pairs, such as the host header 828 “Host:www.acme.com” that indicates the domain to which the request is directed. There are many different headers that may be included. In addition, a request message may also include a request-message body. The body may be encoded in any of various different self-describing encoding languages, often JSON, XML, or HTML. In the current example, there is no request-message body. The service receives the request message containing the GET command, processes the message, and returns a corresponding response message 830. The response message includes an indication of the application-layer protocol 832, a numeric status 834, a textural status 836, various headers 838 and 840, and, in the current example, a body 842 that includes the HTML encoding of a web page. Again, however, the body may contain any of many different types of information, such as a JSON object that encodes a personnel file, customer description, or order description. GET is the most fundamental and generally most often used verb, or function, of the HTTP protocol.

FIG. 8B illustrates the POST HTTP verb. In FIG. 8B, the client sends a POST request 846 to the service that is associated with the URI “http://www.acme.com/item1.” In many RESTful APIs, a POST request message requests that the service create a new resource subordinate to the URI associated with the POST request and provide a name and corresponding URI for the newly created resource. Thus, as shown in FIG. 8B, the service creates a new resource 848 subordinate to resource 810 specified by URI “http://www.acme.com/item1,” and assigns an identifier “36” to this new resource, creating for the new resource the unique URI “http://www.acme.com/item1/36” 850. The service then transmits a response message 852 corresponding to the POST request back to the remote client. In addition to the application-layer protocol, status, and headers 854, the response message includes a location header 856 with the URI of the newly created resource. According to the HTTP protocol, the POST verb may also be used to update existing resources by including a body with update information. However, RESTful APIs generally use POST for creation of new resources when the names for the new resources are determined by the service. The POST request 846 may include a body containing a representation or partial representation of the resource that may be incorporated into stored information for the resource by the service.

FIG. 8C illustrates the PUT HTTP verb. In RESTful APIs, the PUT HTTP verb is generally used for updating existing resources or for creating new resources when the name for the new resources is determined by the client, rather than the service. In the example shown in FIG. 8C, the remote client issues a PUT HTTP request 860 with respect to the URI “http://www.acme.com/item1/36” that names the newly created resource 848. The PUT request message includes a body with a JSON encoding of a representation or partial representation of the resource 862. In response to receiving this request, the service updates resource 848 to include the information 862 transmitted in the PUT request and then returns a response corresponding to the PUT request 864 to the remote client.

FIG. 8D illustrates the DELETE HTTP verb. In the example shown in FIG. 8D, the remote client transmits a DELETE HTTP request 870 with respect to URI “http://www.acme.com/item1/36” that uniquely specifies newly created resource 848 to the service. In response, the service deletes the resource associated with the URL and returns a response message 872.

A service may return, in response messages, various different links, or URIs, in addition to a resource representation. These links may indicate, to the client, additional resources related in various different ways to the resource specified by the URI associated with the corresponding request message. As one example, when the information returned to a client in response to a request is too large for a single HTTP response message, it may be divided into pages, with the first page returned along with additional links, or URIs, that allow the client to retrieve the remaining pages using additional GET requests. As another example, in response to an initial GET request for the customer info resource (710 in FIG. 7), the service may provide URIs 720 and 736 in addition to a requested representation to the client, using which the client may begin to traverse the hierarchical resource organization in subsequent GET requests.

### An Example LLS User Interface

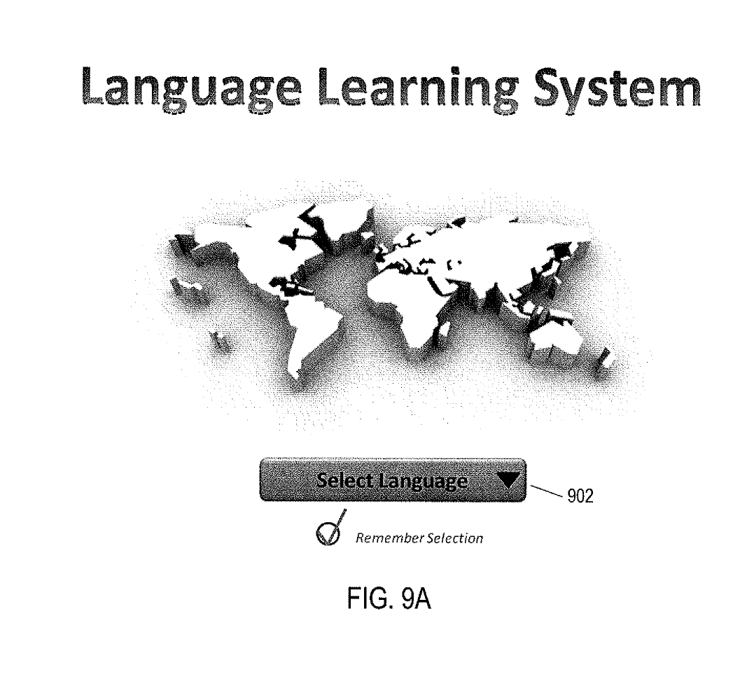

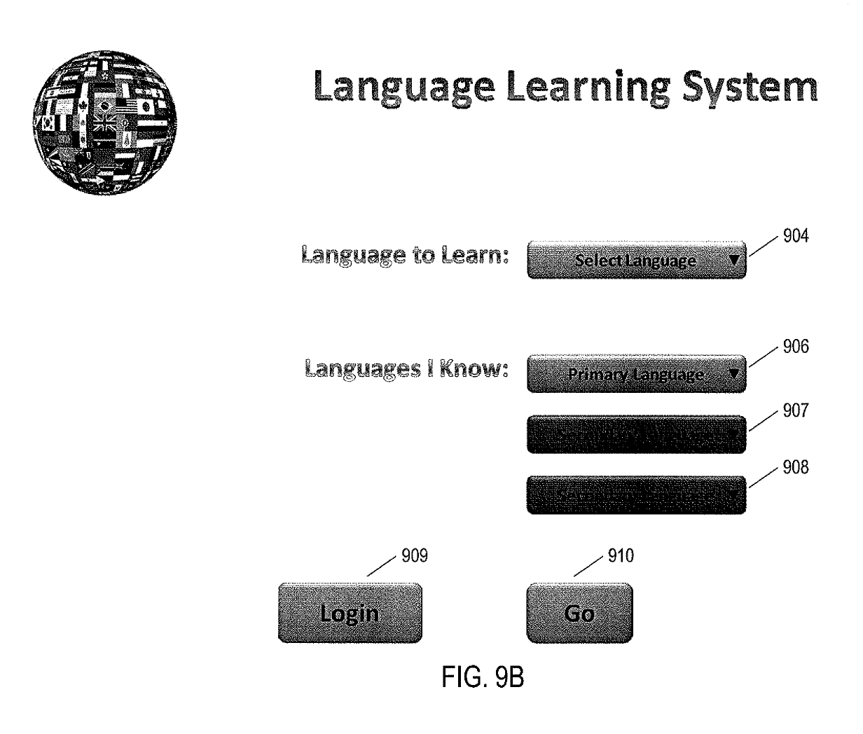

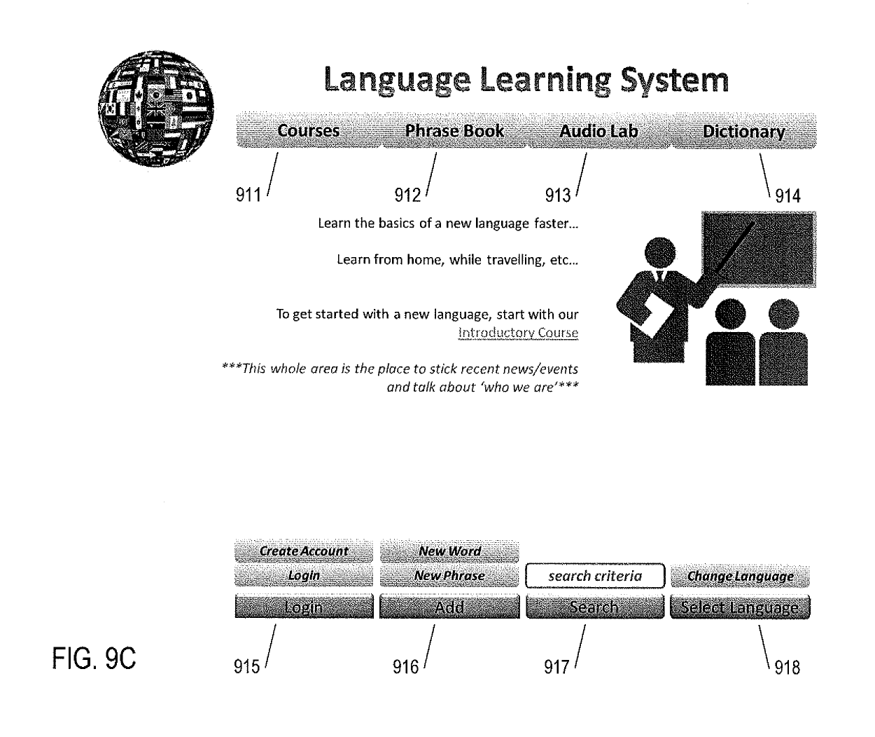

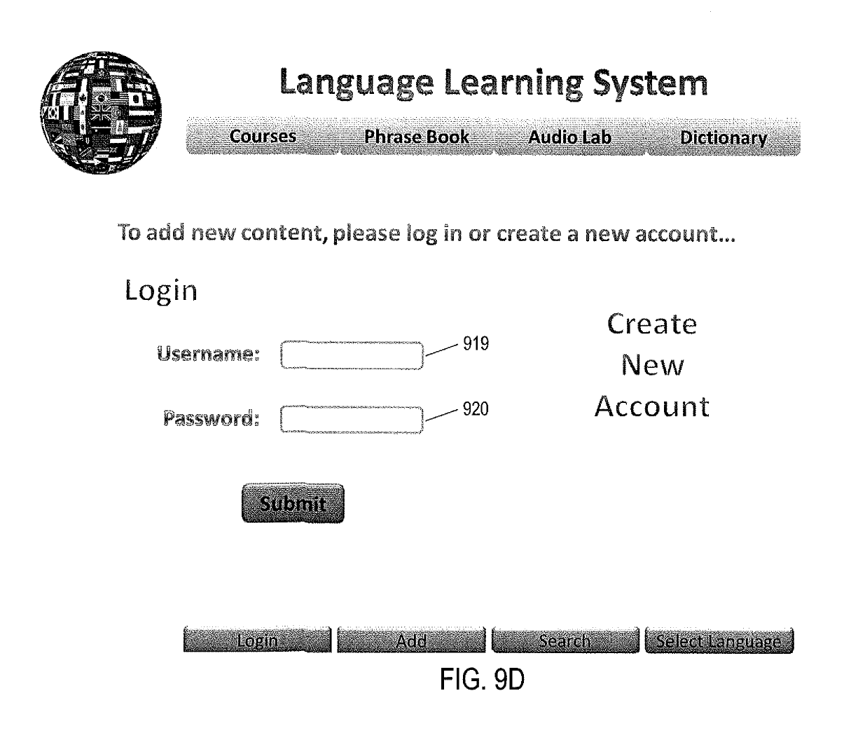

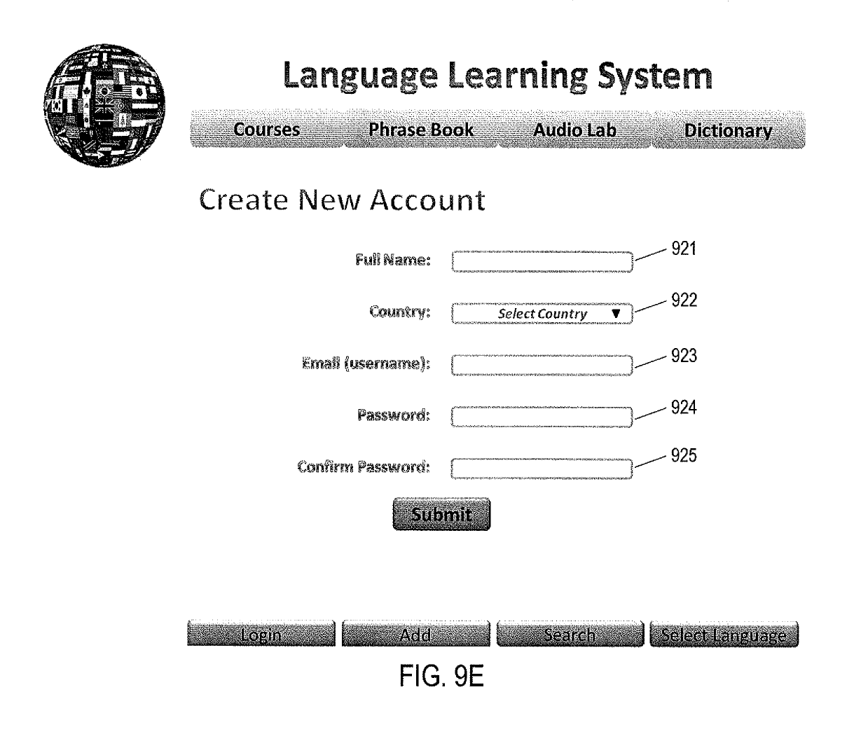

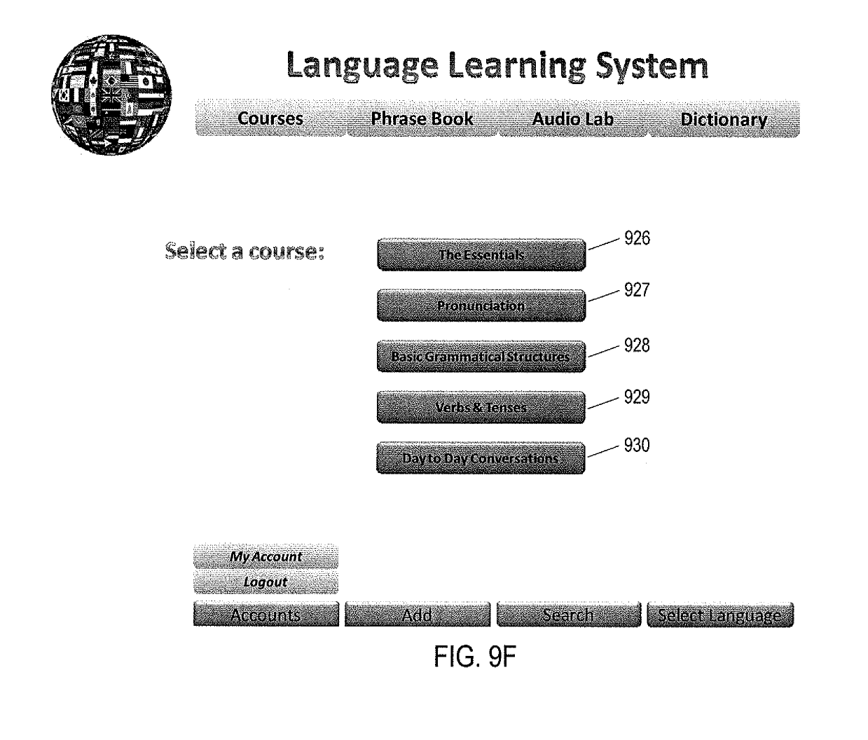

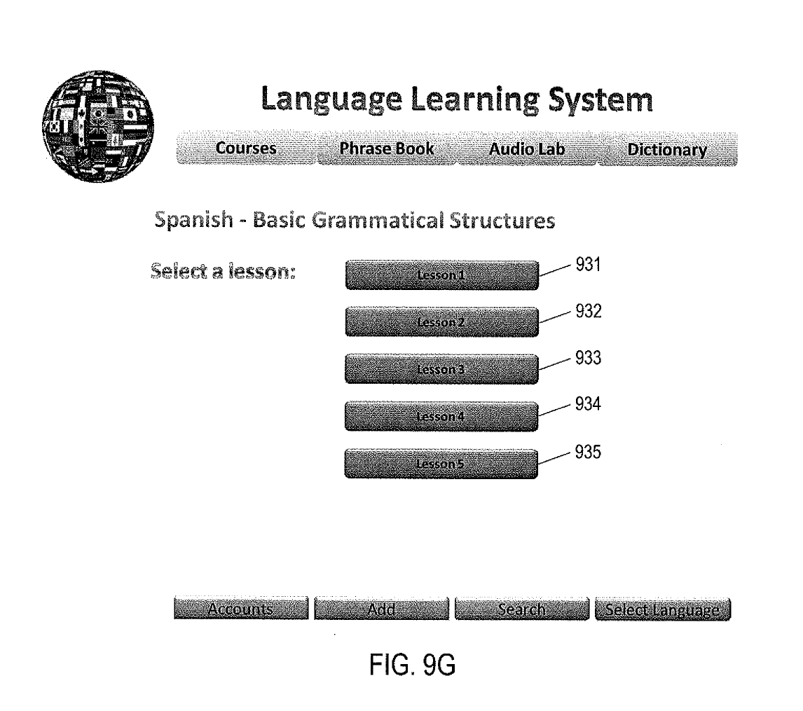

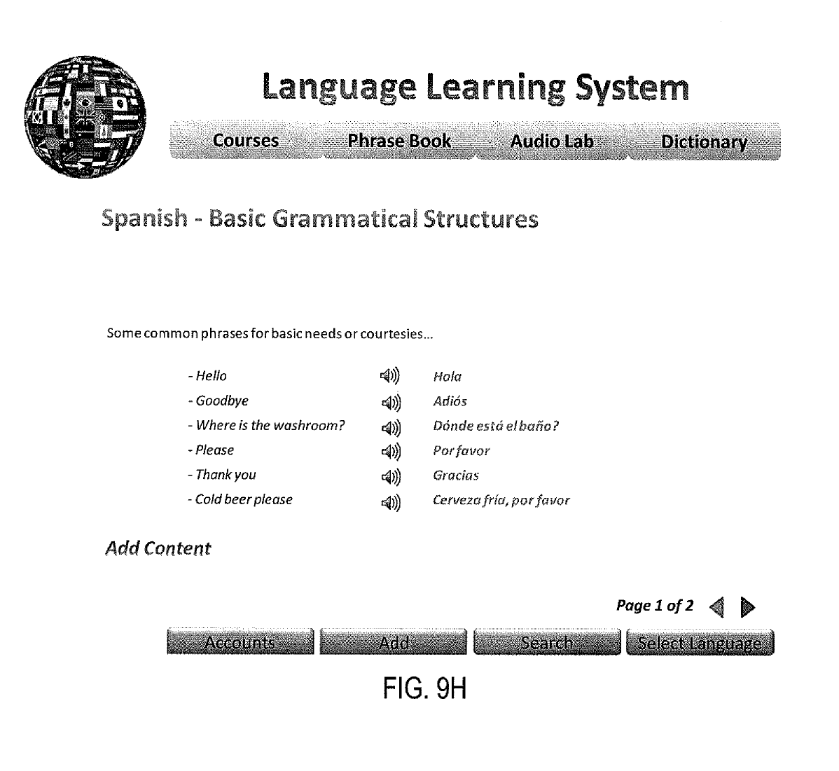

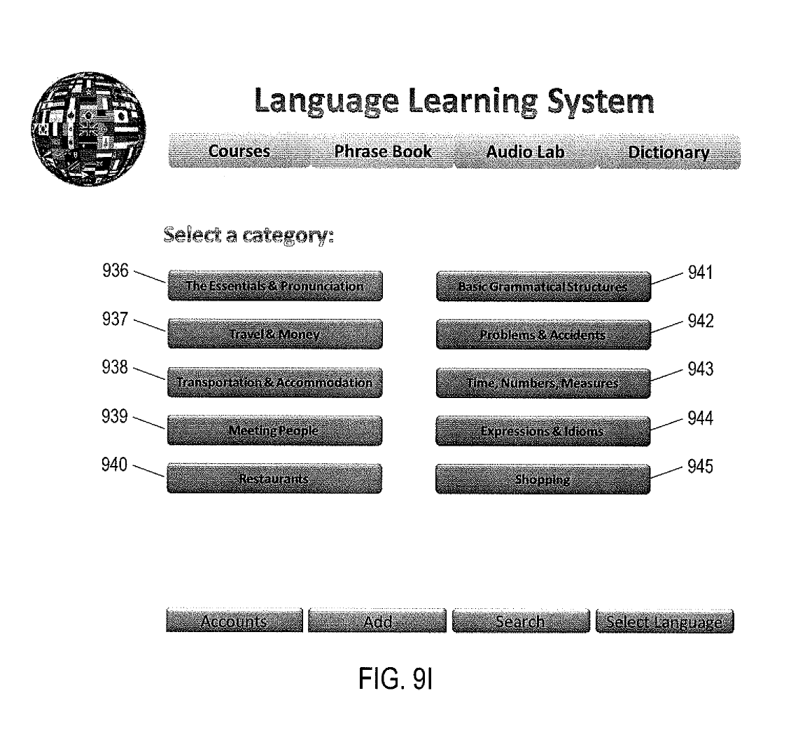

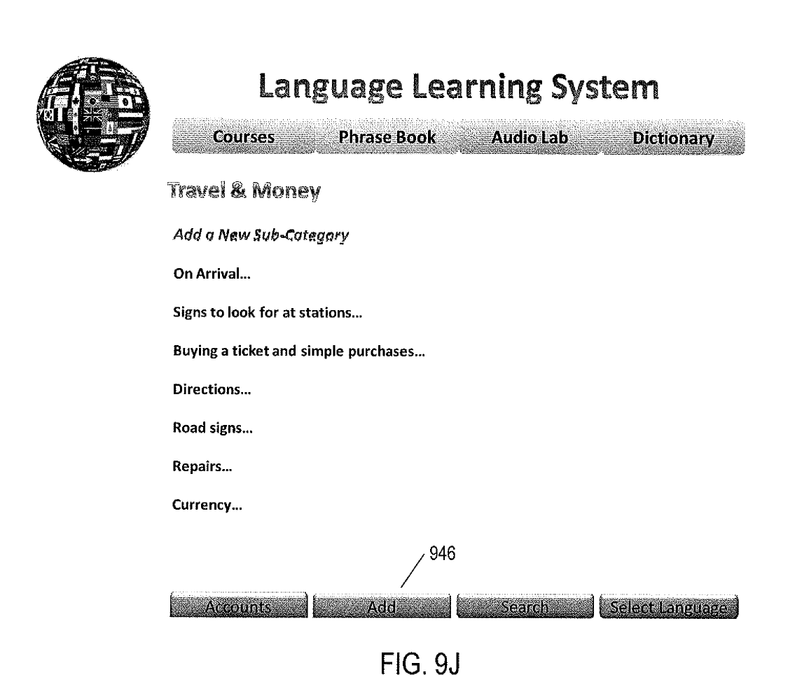

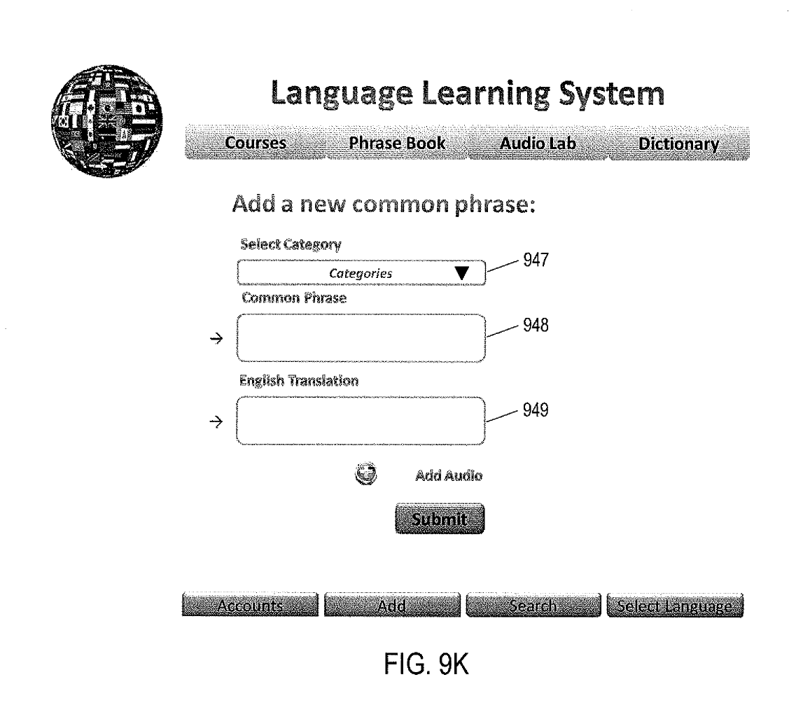

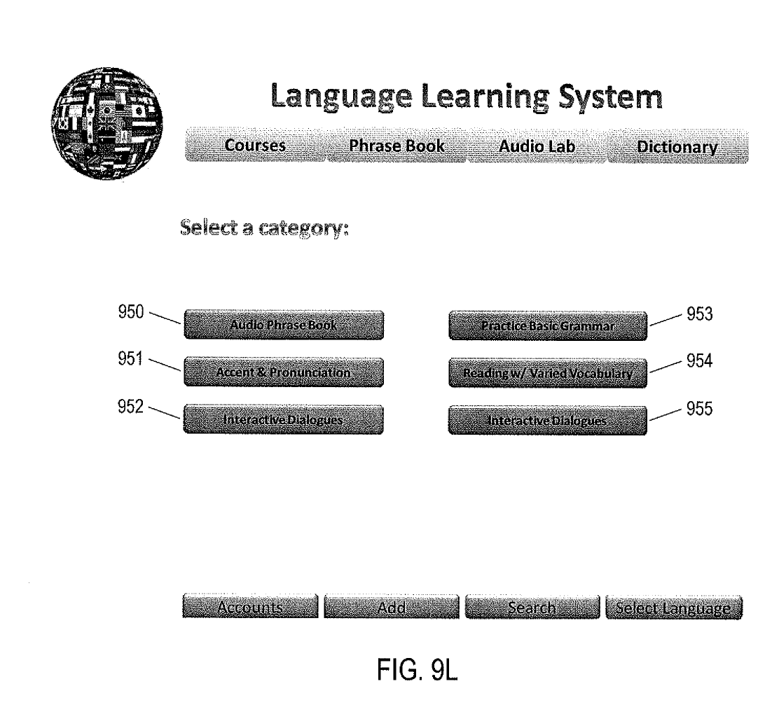

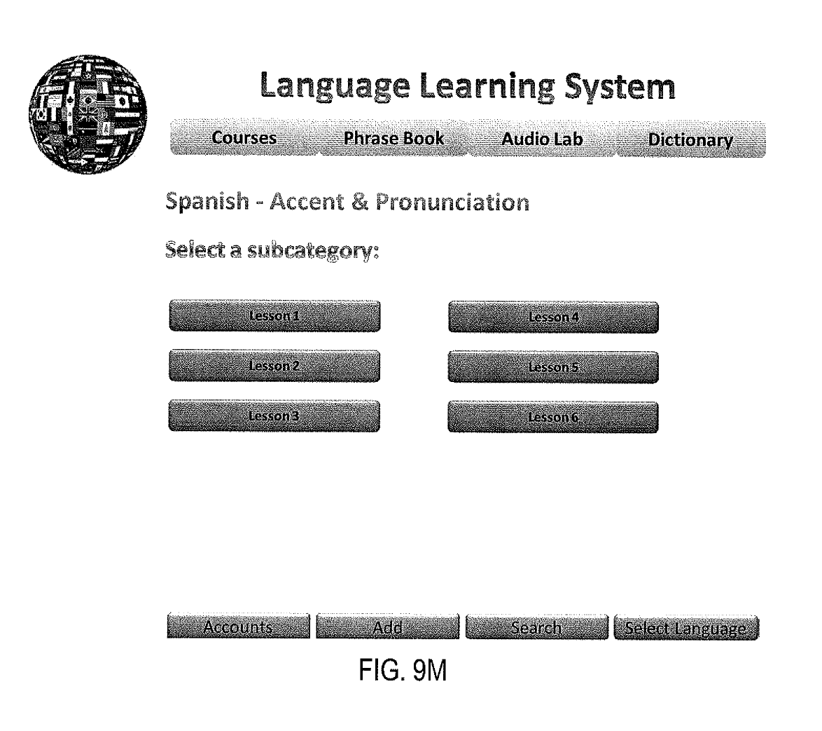

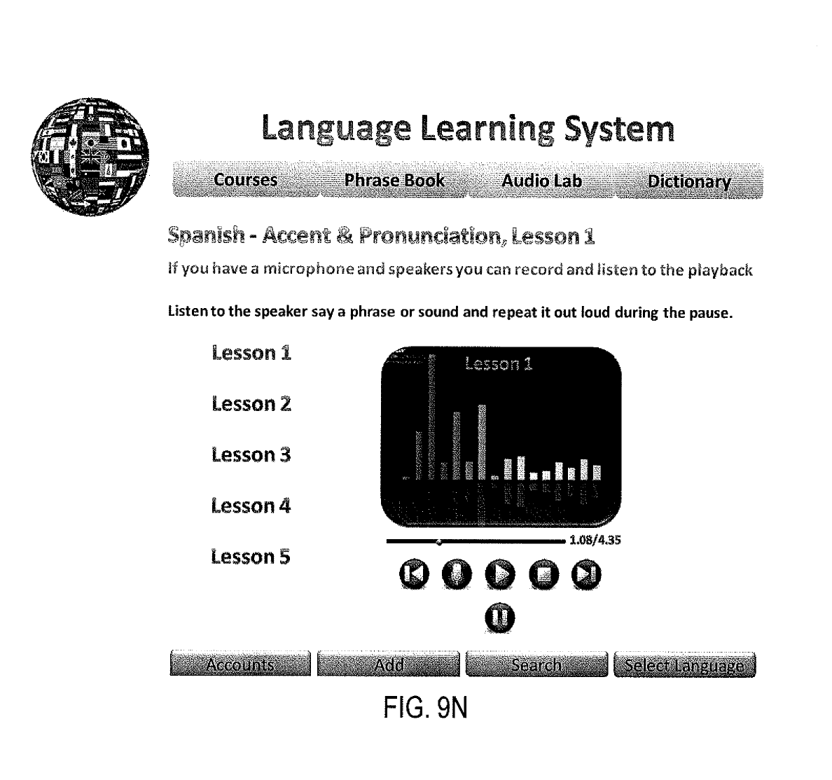

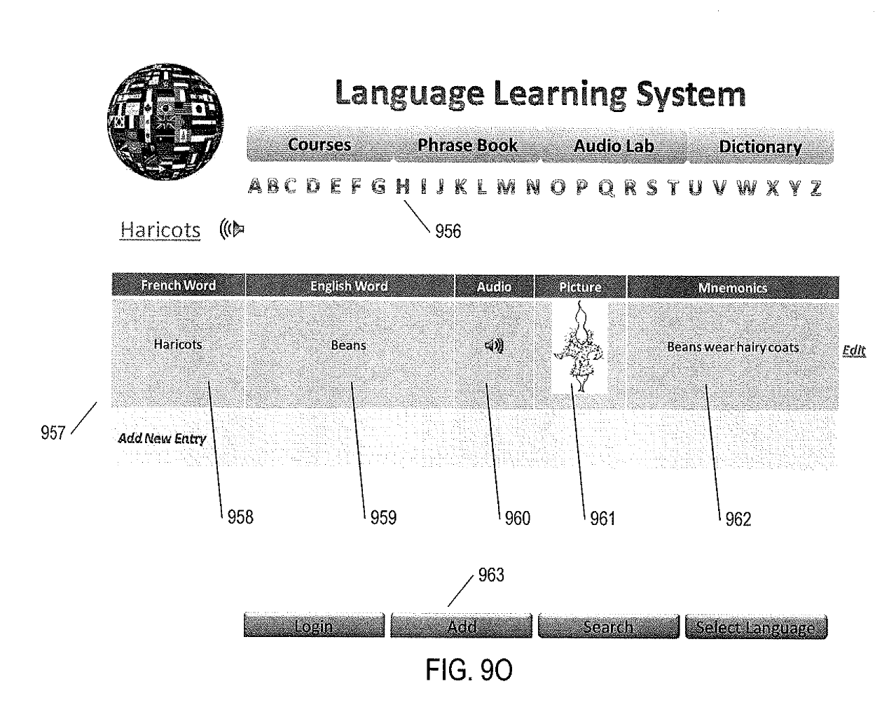

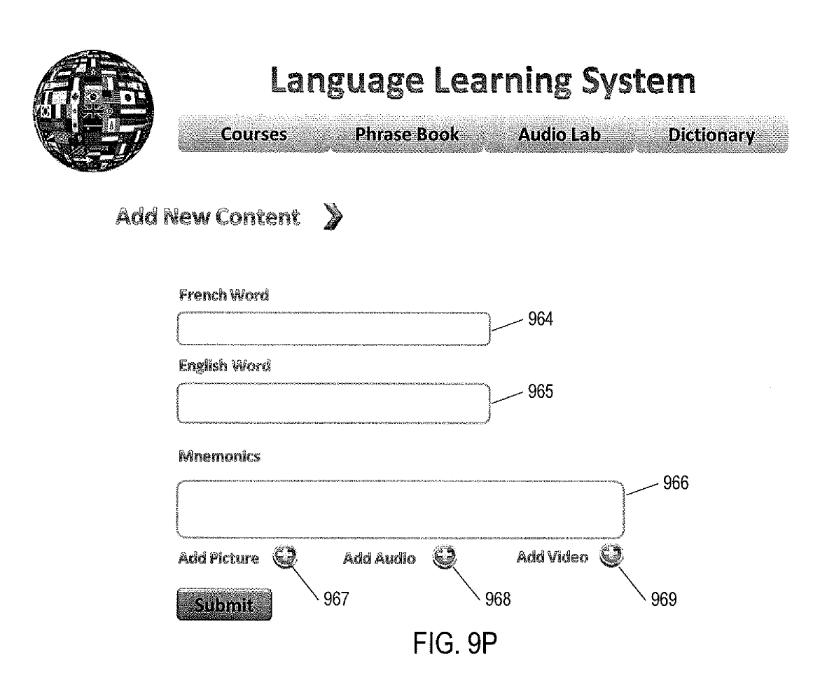

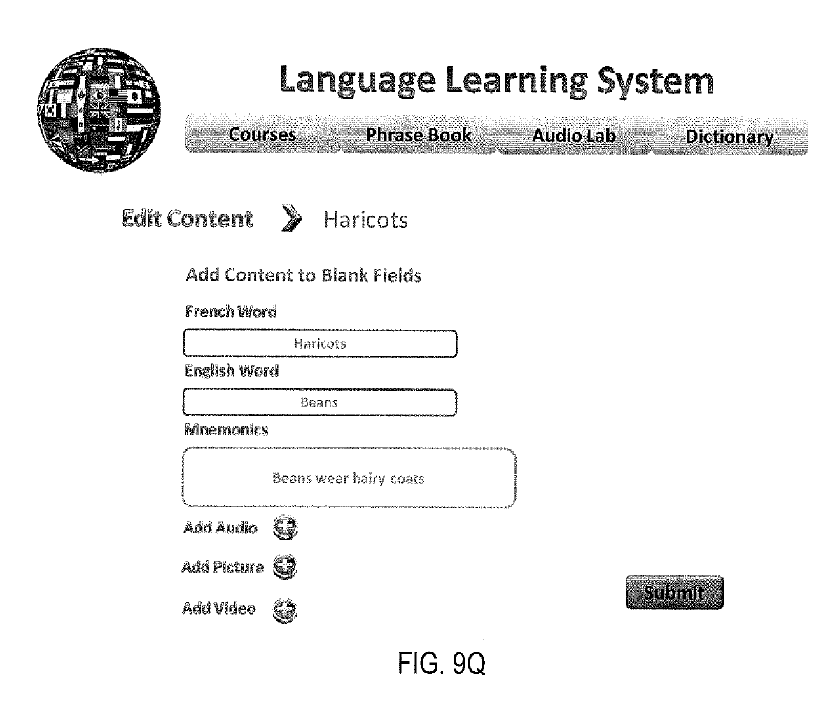

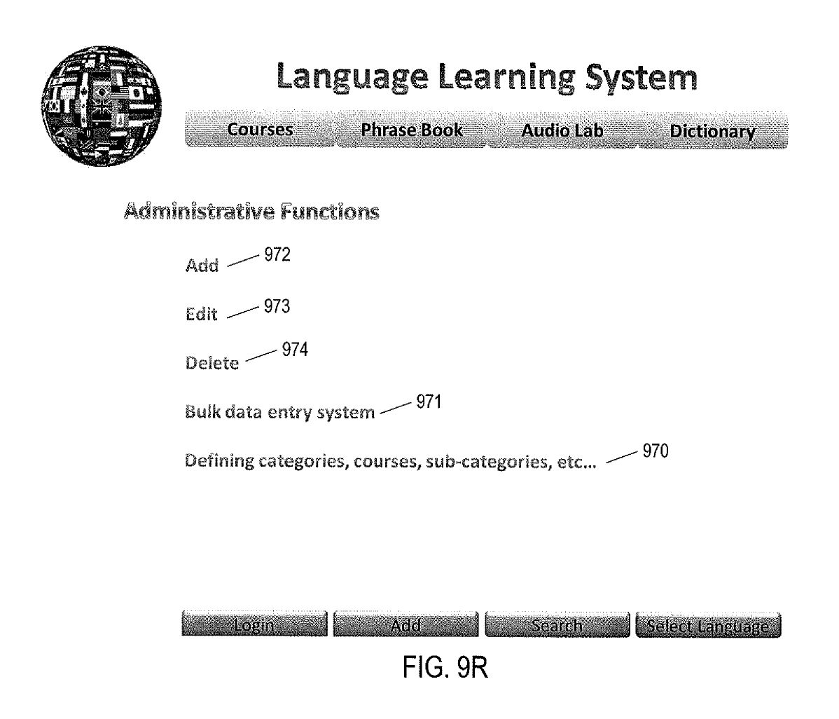

FIGS. 9A-R illustrate, using screenshots, one implementation of a user interface provided to users of the currently disclosed LLS. FIG. 9A shows an initial landing page provided by the LLS. The landing page provides a drop-down selection feature 902 that allows the user to select a language for presentation of information to the user through the user interface.

FIG. 9B shows a second page provided by the user interface. This page includes a drop-down selection feature 904 that allows a user to specify the language the user is seeking to learn as well as a number of additional drop-down selection features 906-908 that allow the user to specify the user's primary and secondary languages. Additional navigation-input features 909-910 allow the user to either log in to the LLS, in order to access information based on the user's login identity or to proceed with language learning.

FIG. 9C shows a navigational page, provided to users following login or input of an indication to proceed with language learning. The navigational page allows a user to access courses 911, access a phrase book 912, access an audio lab 913, or access a dictionary 914. In addition, a user can book a variety of functionalities, including login 915, adding of new words and phrases 916, searching for words and phrases 917, and selecting a different language 918.

FIG. 9D shows a login page provided to users to allow users to log in to the LLS. The login page includes text-entry features through which the user can specify a user name 919 and password 920. FIG. 9E shows a new-account-creation page to which the user can navigate, from the navigation page shown in FIG. 9C, to create a new user account. This page includes text-entry features for specifying the user's name 921, selecting the user's country 922, specifying the user's email 923, and specifying a password for the user 924-925.

FIG. 9F shows a course-selection page provided to a user through the user interface when the user navigates to the course's functionality of the LLS. The course-selection page includes selection features 926-930 that allow the user to select one of various courses provided for the foreign language previously selected by the user. When, for example, the user selects the course “Basic Grammatical Structures” 928, a series of selection features 931-935 for basic-grammatical-structure lessons are provided to the user for selection in the page shown in FIG. 9G. An example basic-grammatical-structure lesson is shown in FIG. 9H.

When a user navigates to the phrase-book portion of the LLS user interface, the user is presented, as shown in FIG. 9I, with a series of selection features for phrases of particular categories 936-945. FIG. 9J shows certain of the phrases associated with the phrase category “Travel & Money.” A user can also add a phrase by input to the “Add” selection feature 946, which provides the user with a phrase-addition page, shown in FIG. 9K. The phrase-addition page provides a selection feature 947 that allows the user to select a category for the phrase as well as text-entry features 948 and 949 that allow the user to input the phrase both in the native language as well as in English, given that English is the selected user-interface language.

When a user enters the audio-lab portion of the LLS user interface, the user is provided with the audio-lab selection page, as shown in FIG. 9L, that allows the user to select various types of audio programs through selection features 950-955. FIG. 9M shows a lesson-selection page for the “Accent & Pronunciation” audio category, and FIG. 9N shows a first lesson page in the Accent & Pronunciation category. In the dictionary portion of the LLS user interface, as shown in FIG. 9O, a user may select dictionary entries by first letter. For example, in FIG. 9O, selection of the letter “H” 956 results in display of a first French word, given that French is the selected learning language, “haricots,” for which a dictionary entry has been prepared 957. The dictionary entry 957 includes text for the selected French word 958, the English-language translation for the French word 959, an audio file in which the French word is pronounced 960, a picture portion of a mnemonic for the French word 961, and a phrase portion for the mnemonic associated with the French word 962. When a user selects the “Add” section feature 963, a dictionary-entry-creation page is provided to the user, as shown in FIG. 9P, for entry of a new dictionary entry. This page includes text-entry features for entering the French word 964, the corresponding English word 965, a textural mnemonic portion 966, and includes additional features that allow the user to add a graphic or picture 967, an audio file 968, and a video 969 to the entry. FIG. 9Q shows the dictionary-entry page filled out to specify the dictionary entry 957 shown in FIG. 9O.

Finally, the LLS supports various types of administrative functions. Administrative functions may be selectively accessible to various categories of users, such as forum moderators, teachers, or general users. Administration functions may allow administrators to define and input categories, courses, and other such organizational features 970, import bulk data into the LLS 971, and add, edit, and delete categories, courses, subcategories, dictionary entries, and other informational features 972-974.

### Implementation of the LLS

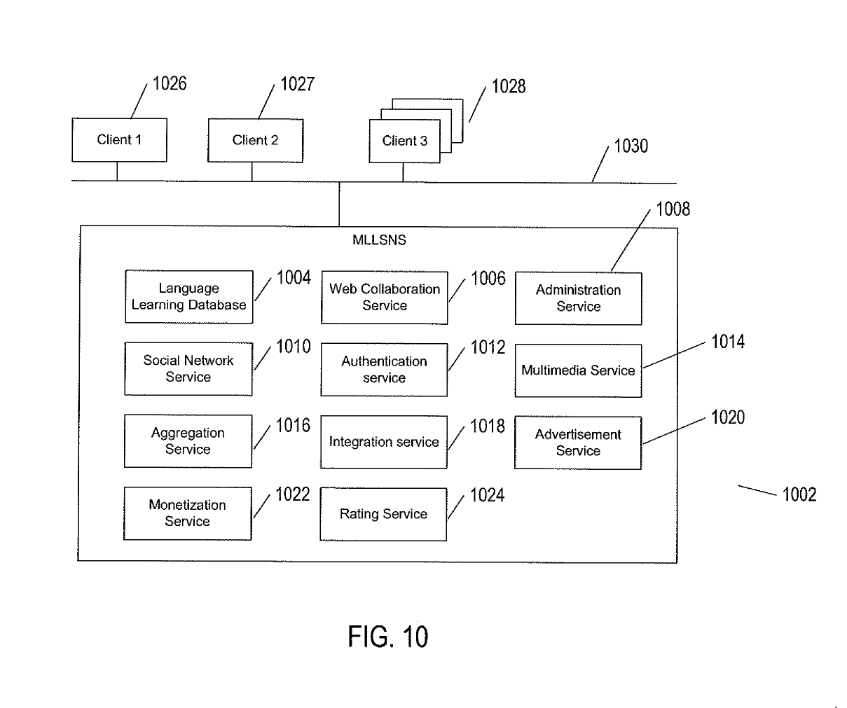

FIG. 10 shows a block diagram of one implementation of the currently disclosed LLS. The LLS 1002, in the described implementation, includes a language-learning-database service 1004, a web-collaboration service 1006, an administration service 1008, a social-network service 1010, an authentication service 1012, a multimedia service 1014, an aggregation service 1016, an integration service 1018, an advertisement service 1020, a monetization service 1022, and a rating service 1024. Clients 1026-1028 connect to the LLS via local area networks and the Internet 1030.

The language-learning database service 1004 stores and provides words, translations, synonyms, groups of words, learning materials, learning courses, and other such informational elements as well as inter-informational-element links. The language-learning-database service supports multiple languages and sets of mnemonics. The language-learning-database service may access a single database or multiple databases that store the various information elements provided, as a service, by the language-learning-database service.

The web-collaboration service 1006 manages collaborative activities of users that allow users to create and share information elements stored within the language-learning-database service. As one example, the web-collaboration service may support an online-encyclopedia-like collection of sets of mnemonics associated with words and phrases of various languages, with users collaborating to create and maintain the mnemonics as a shared foreign-language-learning resource.

The administration service 1008 provides an administration interface for LLS administrators as well as an account-management interface to users that allows users to manage their own user accounts. The social-network service 1010 provides a variety of social-networking functions, including instant messaging, voice-over-the-Internet communications and other types of audio/video real-time communications, various Internet forums and chat rooms, web blogs, social bookmarking, mailing lists, and other such social-networking functionality. The social-network service 1010 provides the communications and resource-sharing functionalities that support the evolution of various types of social networks on top of the basic language-learning functionalities provided by the LLS.

The authentication service 1012 authenticates users of the LLS by verifying user identities during login processes using passwords, digital certificates, and other such authentication mechanisms. The authentication service may also provide for user authorization, allowing users to assume various roles with respect to the LLS depending on authorization policies granted to users by LLS administrators. For example, a user may be authorized to assume the role of a forum moderator or mnemonics-set curator.

The multimedia service 1014 manages storage, retrieval, and rendering of audio, video, graphics, and other multimedia information. The aggregation service 1016 includes a variety of different functionalities that allow the LLS to aggregate information identified in, and collected from, a variety of different data sources accessible to the LLS, including web sites, online data sources, online searching facilities, and other such accessible data sources. The integration service 1018 provides an application-programming-interface (“API”) interface to the LLS that can be used by a variety of external web services in order to receive services from the LLS. For example, the API provides one or more function calls, generally implemented using a RESTful protocol, that would allow an authorized external web service to request and receive a mnemonic for a particular word of a particular foreign language.

The advertisement service 1020 provides a mechanism for advertising content to be received from business partners of the LLS and provided, through the LLS user interface, to users of the LLS. The monetization service 1022 includes various types of functionalities for collecting revenues from business partners, such as collecting revenues for displayed advertisements. The monetization service may also support subscription-based, license-based, and pay-per-use-based revenue collection. Finally, the rating service 1024 allows users of the LLS to rate the various different items, features, and functionalities provided by the LLS to users.

In general, the LLS is implemented within virtual servers of a commercial cloud-computing facility. However, the LLS may also be implemented with a stand-alone Internet-accessible system. While the LLS provides the variety of services discussed with reference to FIG. 10, client computers also run LLS client-side applications, in general, downloaded from the LLS, which instantiate a LLS user interface on the client device and coordinate the transfer of requests from the client computers to the LLS, reception of responses to requests from the LLS, and rendering of LLS-provided information to users of the client computers.

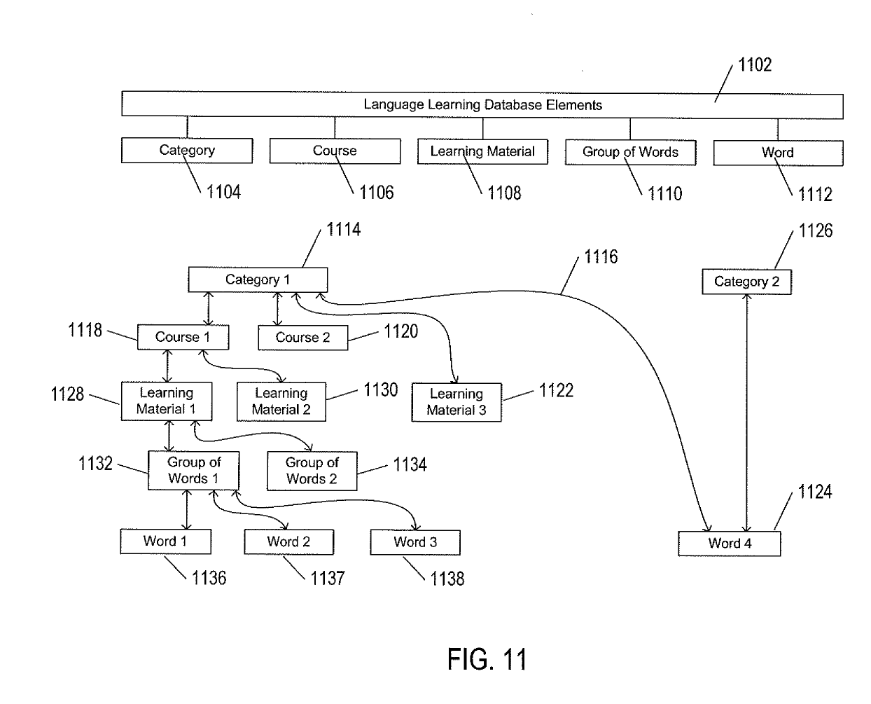

FIG. 11 illustrates the storage of information elements by the language-learning-database service. The information elements 1102 include categories 1104, such as the various phrase categories discussed above in the previous section, courses 1106, learning materials 1108 such as illustrated stories, text associated with foreign-language words, and individual language-learning sessions or lessons, all of which may be incorporated into courses, groups of words 1110 for memorization and learning, and individual words 1112 for memorization and learning. The words and groups of words may be included in dictionaries, lists of mnemonic-associated foreign words, and other collections of information.

The various types of information elements may be linked together in a variety of different ways for a variety of different purposes by the LLS. For example, as also shown in FIG. 11, various types of information elements, shown as rectangles, such as information element 1114, may be linked together with links or hyperlinks, shown as curved arrows, such as curved arrow 1116, to generate a higher-order type of information. A category 1114 may be linked to, and associated with, several different courses 1118 and 1120 as well as to a particular learning-material instance 1122 and a key word 1124 that is, in turn, associated with yet an additional category 12126. Leaning materials 1128 and 1130 associated with a particular course 1118 may be, in addition, associated with different groups of words 1132 and 1134, each of which is associated with a set of individual words 1136-1138. Each individual information element may be multiply linked to different information elements in different contexts, with sets of links associated with different contexts to create different higher-order information associated with the contexts. The various linked structures representing higher-order information may be additionally indexed and cross-referenced and may, in addition, be searched by application of a variety of different search facilities.

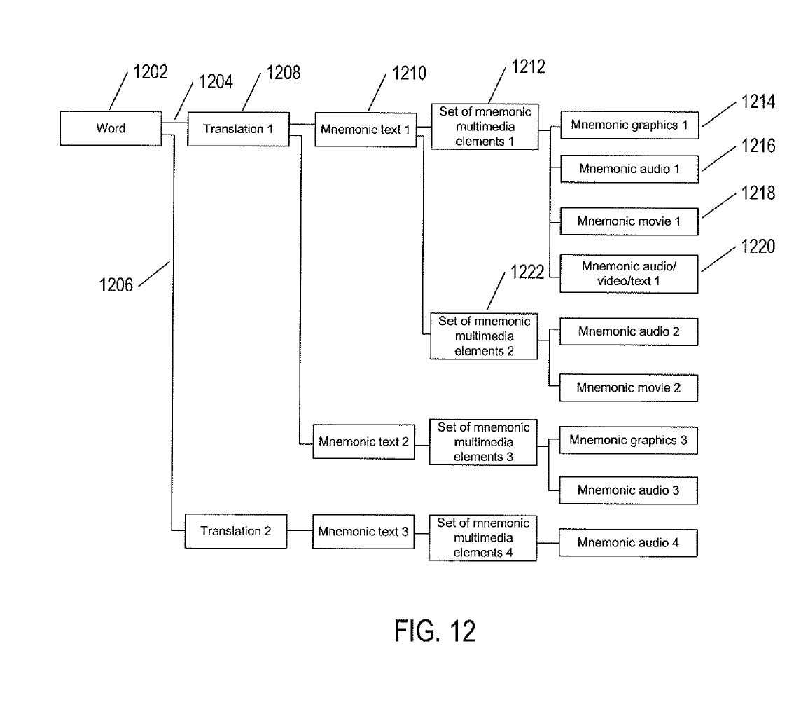

FIG. 12 shows a more detailed representation of a word data structure that is used, by the language-learning-database service, to store information associated with a particular foreign-language word. The word 1202 may be texturally represented, and is generally a language-specific word entry of a language-specific dictionary entry or other language-specific information resource. The word is linked, via links 1204 and 1206, to linked substructures that each represent a translation and associated mnemonics for the word in various different foreign languages. Each substructure includes a textural translation for the word in a particular target language 1208 which, in turn, may be associated with one or more mnemonic substructures for the translation. A mnemonic substructure generally includes mnemonic text 1210 and a set of mnemonic multimedia elements 1212. This set may include a graphic 1214, an audio file 1216, a video file 1218, and a more complex multimedia object 1220. A particular mnemonic 1210 may be associated with multiple different sets of multimedia elements 1212 and 1222.

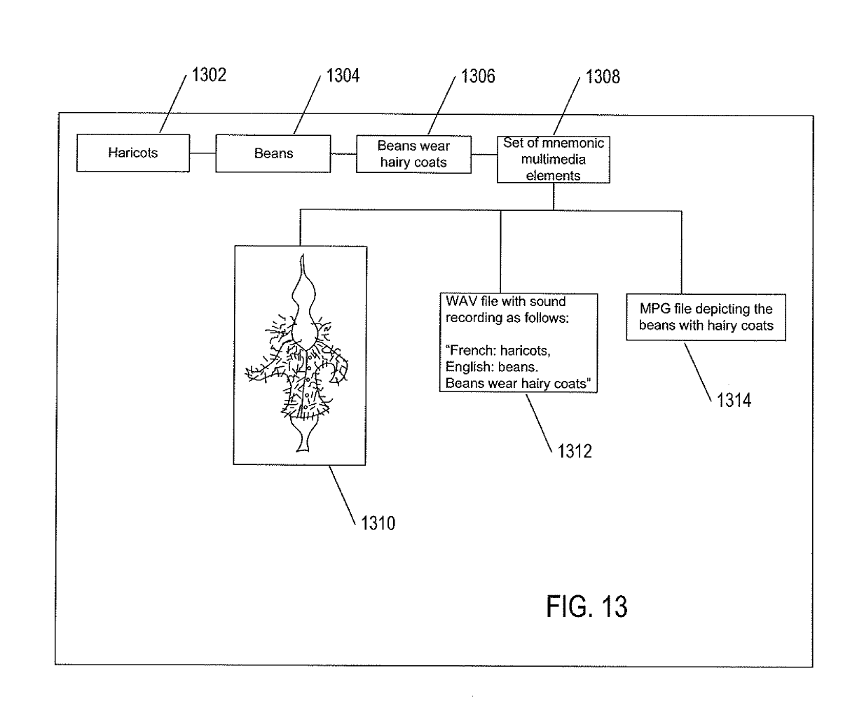

FIG. 13 illustrates a specific example of a word data structure, described generally above with reference to FIG. 12. In this case, the word is the French word “haricots” 1302 and the English-language translation is “beans” 1304. This translation is associated with a single mnemonic 1306, “beans wear hairy coats,” which is associated with a single set of mnemonic multimedia elements 1308 that includes a graphic 1310, an audio file 1312, and a video file 1314.

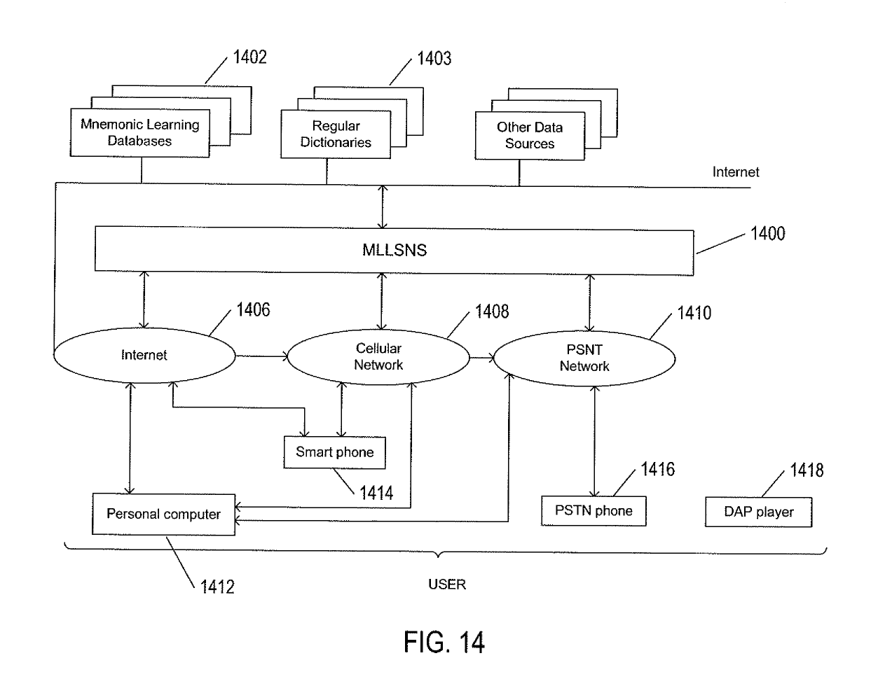

FIG. 14 provides a block diagram that illustrates aggregation of information by the LLS. As discussed above, the LLS may access and aggregate information from a variety of different Internet-accessible data sources 1402-1404. Furthermore, the LLS 1400 can be accessed, by a user, through a variety of different communications media, including the Internet 1406, cellular networks 1408, and the public switch telephone network 1410 via a variety of different user devices, including personal computers 1412, smart phones 1414, landline phones 1416, and other devices 1418.

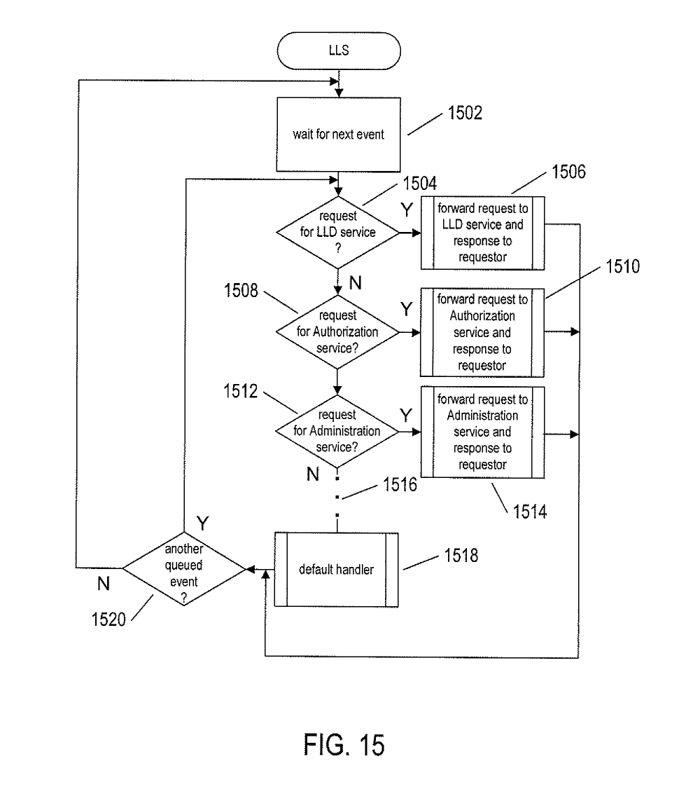

FIG. 15 provides a control-flow-diagram illustration of the basic operation of the currently disclosed LLS. In step 1502, the LLS waits for a next event to occur. When that event is reception of a request, from a remote client, for data from the language-learning-database service, as determined in step 1504, then the request is forwarded to the language-learning-database service and a response received back from the service is returned to the requestor, in step 1506. Similarly, when the event is a request for the authentication service, as determined in step 1508, that request is forwarded to the authentication service and a response from the authentication service is returned to the requestor, in step 1510. Similarly, when the request is a request from a remote client for an administration service, as determined in step 1512, then the request is forwarded to the administration service and a response from the administration service is returned to the requestor, in step 1514. As represented by ellipses 1516, any of a variety of additional types of events may occur for which the LLS invokes an appropriate handler. In general, a default handler 1518 catches any rare or unforeseen events and carries out appropriate handling. When another event has been dequeued, as determined in step 1520, then control returns to the top of the event-determination steps. Otherwise, control returns to the waiting step 1502.

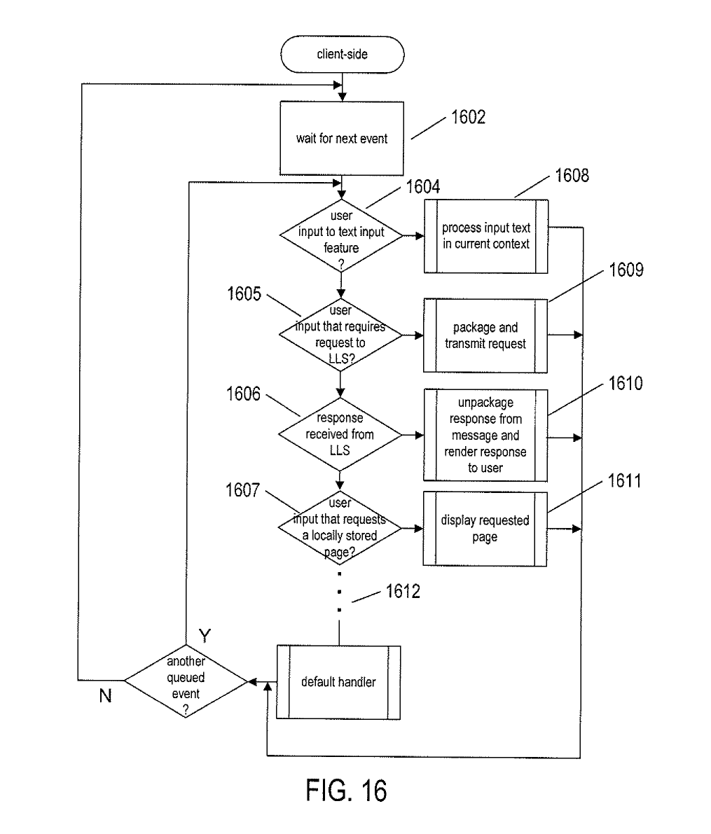

FIG. 16 provides a similar control-flow diagram to that provided in FIG. 15 with a client-side application or component of the LLS. Again, the client-side application essentially waits, in step 1602, for the occurrence of a next event and, in a series of conditional steps 1604-1607, determines the nature of the event that has occurred and then calls an appropriate handler 1608-1611, respectively, to handle the event. Many additional types of events may occur and be handled, as represented by ellipses 1612. Thus, in general, the LLS system waits for next requests from clients and responds to those requests while the client-side application generally waits either for responses from the LLS, which are unpackaged and processed, including rendering data for display to the user, or waits for user input that may trigger requests to the LLS or to display of locally stored pages.

Although the present invention has been described in terms of particular embodiments, it is not intended that the invention be limited to these embodiments. Modifications within the spirit of the invention will be apparent to those skilled in the art. For example, any of many different computer-based mnemonics-based methods and systems can be obtained by varying any of a variety of different design and implementation parameters, including choices of hardware and communications platforms, programming languages, operating systems, virtualization systems, control structures, data structures, modular organization, and other such design and implementation parameters.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A computer-based and mnemonics-based language-learning system comprising:
a hardware and communications platform that includes one or more servers, each of which, in turn, includes one or more processors, one or more memories, and stored computer instructions that, when executed by the processors, control the processors to
receive a request from a remote client for a set of mnemonics associated with a word;
access a language-learning-database service to retrieve the set of mnemonics; and
return the retrieved set of mnemonics to the remote client.
